(19) United States
(12) Patent Application Publication
(10) Pub. No.: US 2013/0226941 A1
(43) Pub. Date: Aug. 29, 2013

(54) SYSTEM AND METHOD FOR CLASSIFYING SIGNALS USING THE BLOOM FILTER

(71) Applicants: Ramakumar Kosuru, Austin, TX (US); Choudur Lakshminarayan, Austin, TX (US)

(72) Inventors: Ramakumar Kosuru, Austin, TX (US); Choudur Lakshminarayan, Austin, TX (US)

(21) Appl. No.: 13/407,540

(22) Filed: Feb. 28, 2012

(51) Int. Cl. G06F 17/30

(52) U.S. Cl. 707/754; 707/E17.134

(57) ABSTRACT

The present disclosure generally relates to data processing. Bloom filters are used to process data at high speed. A Bloom filter that is initialized based on a source string can be used to quickly determine the similarity between the source string and a query string.

### BACKGROUND

The present disclosure generally relates to data processing methods.

Since the invention of computer, the processing power of computer systems continues to improve, more or less following the famous Moore's Law. With ever increasing computing power, more and more data intensive applications are being developed. It is now not uncommon to see a database that stores many billions records running into peta bytes of data storage. Often, it is desirable to quickly analyze the data to obtain interesting information.

### BRIEF DESCRIPTION OF THE DRAWINGS

FIG. 1 is a simplified diagram illustrating a Bloom filter. It shows an m bit array.

FIG. 2A is a simplified flow diagram illustrating a process for setting up a Bloom filter with various substrings of an input string.

FIG. 2B is a simplified diagram illustrating a process for forming a Bloom filter.

FIG. 3 is a simplified flow diagram illustrating a process for determining whether a query string is similar a source string.

FIG. 4 is a simplified diagram illustrating a suitably configured computer that can be used to execute the methods illustrated in FIGS. 1-3.

### DETAILED DESCRIPTION

The present disclosure generally relates to data processing. Bloom filters are used to process data at high speed. A Bloom filter that is initialized based on a source string can be used to quickly determine the similarity between the source string and a query string.

It is often useful to determine whether a query string, or a segment of the query string, is present in a source file. For example, there are many real world applications in determining whether a specific pattern exists in an input file, such as classification based on pattern matching, searching, and others. To make this kind of determination, it is typically necessary to search through the entire source file for the input string, which is computationally expensive and slow. For example, matching strings of information often involves template matching and matching time-series embedding generated by non-linear dynamical systems. The time-series is typically converted into a frequency domain via Fourier methods, and the power spectra of the source time-series and query time-series are compared via likelihood ratio methods/density methods and the Corr-entropy measures. These methods are often not fast enough for a variety of applications.

To make similarity determinations, it often involves template matching and matching time-series embedding generated by a non-linear dynamical systems. Also the time-series is typically converted into a frequency domain via Fourier methods, and the power spectra of the source time-series and query time-series are compared via likelihood ratio methods/density methods and the corr-entropy measures. These methods are often slow and computationally expensive. Thus, it is desirable to have methods and systems for quickly determining whether a source file contains a substring.

The present disclosure describes techniques for determining whether a source file contains a substring using Bloom filters. Bloom filters are generated by processing the source file using hash functions. To determine whether a source file contains a substring, a Bloom filter (which can be much smaller than the source file in size) based on the source is used, thereby allowing for quick determination. It is be appreciated that in many applications, where speed at which an answered is provided is more important than 100% certainty, techniques described in the present disclosure can provide advantages in computational speed and cost.

As an example, a source string of binary values of a given length is compared with a query string (of possibly unequal length) to determine whether or not the source string is similar. Furthermore, it is possible to determine a substring in the source string is in alignment/matched to the query string. The process is light-weight and can be implemented on-line in real-time.

The use of Bloom filters is conceived and developed by Burton Howard Bloom. Bloom filter is a data structure can be used to test whether an element is a member of a set. Often used for making approximation, Bloom filters sometimes turn out false positives, but never false negatives. The accuracy of a given Bloom filters depends on various factors, which can be adjusted according to the needs of particular applications.

To use a Bloom filter, a Bloom filter needs to be initialized. For example, an empty Bloom filter having m bits (all set to 0 initially) is to be initialized by k hash functions that maps information into the Bloom filter. Once the Bloom filter is initialized based on a source file, the Bloom filter can be used to determine whether a query string exists in the source file.

As an example, a use case involves two bit strings of arbitrary length, one is a source string and the other is a query string. The goal is to have an output that is a decision informing the user if there is a substring (of a given size) of the query string in the substring. For example, the source string is as follows:

Source string: 010100001110101010000011110000

And the query string is as follows:

Query string: 1000110000111101010101

Similarities between the source string and the query string are to be determined. For example, a measurement of similarity can be based on whether there is a substring of a given size of the query string in the source string. The size of the substring is referred to as “window size.” For example, for a window size of 3 bits, the source string and query string are similar, as both strings contain a substring of “100”. On the other hand, for the window size that equals to the length of the query string, the source string and the query string are not similar. Depending on the application, different window size can be selected.

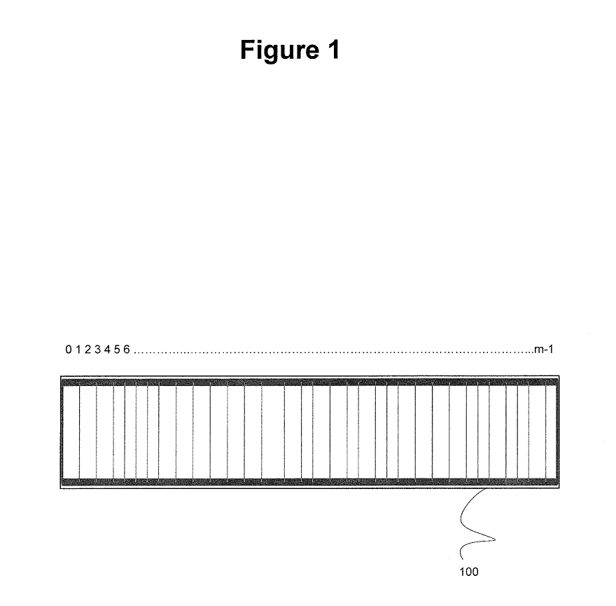

FIG. 1 is a simplified diagram illustrating a Bloom filter. This diagram is merely an example, which should not unduly limit the scope of the claims herein. One of ordinary skill in the art would recognize other variations, modifications, and alternatives. The Bloom filter 100 shown in FIG. 1 comprises m bits, starting from bit 0 to bit m−1. Initially, all of the m bits are set to 0. After k hash functions are performed, corresponding bits in the Bloom filter 100 are set, and the Bloom filter is ready to be used. For example, k functions are performed on segments of a source string.

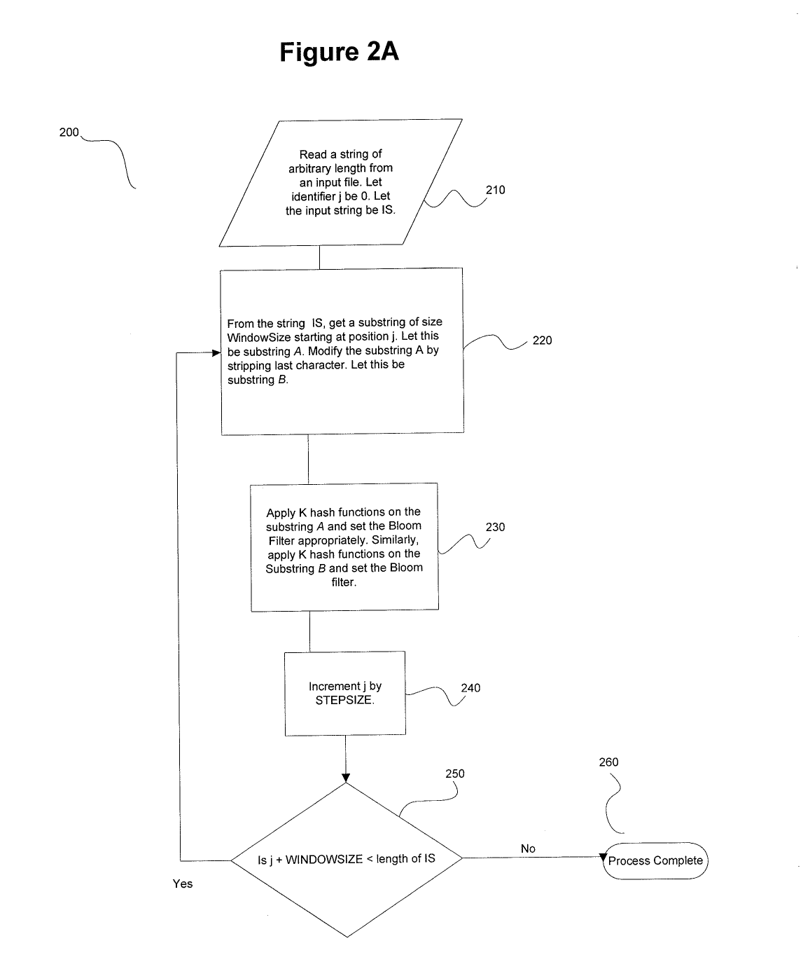

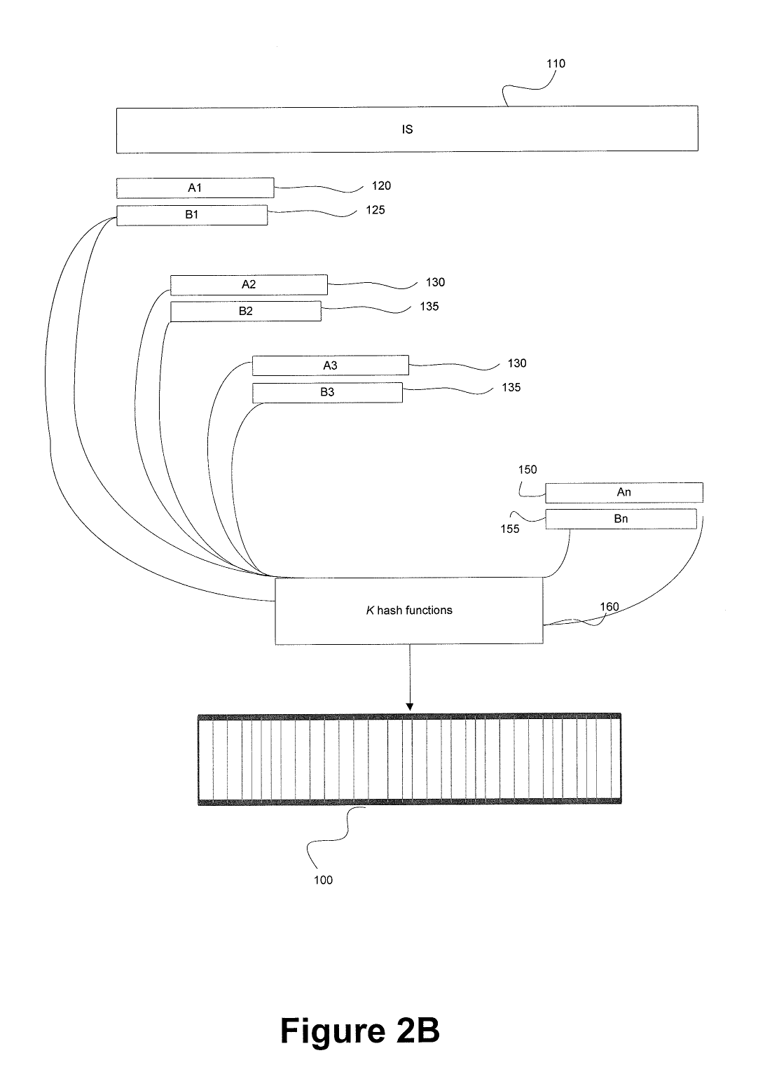

FIG. 2A is a simplified flow diagram illustrating a process for providing a Bloom filter. This diagram is merely an example, which should not unduly limit the scope of the claims herein. One of ordinary skill in the art would recognize other variations, modifications, and alternatives. For example, various steps illustrated in FIG. 2 can be added, removed, modified, replaced, repeated, re-arranged, and/or overlapped. The process 200 starts at step 210. At step 210, an input file is processed and a string of arbitrary length (e.g., input string “IS”) from the input file is read. To provide an example, a counter or identifier j is used, and initially the j has a value of 0 (j may have other values as well, which means the Substrings of IS used in setting the Bloom filter does not start at the first bit of string IS). At step 220, a substring of size “WindowsSize” starting at position j is used to generate “Substring A”, and by removing the last character in Substring A, Substring B is provided. At step 230, k hash functions are applied to the substring A, and the Bloom Filter is set accordingly appropriately. Similarly, k hash functions are applied on the Substring B to set the Bloom filter. At step 240, the counter j is increased by the variable STEPSIZE. For example, the variable STEPSIZE dictates how many substrings A and B are to be processed in setting the Bloom filter. At step 250, it is determined whether (j+WindowSize) is greater than the length of the string IS. If so, step 260 is performed, as Bloom filter is set and process is complete; if not, then the process goes back to step 220. The number of iterations required to set the Bloom filter depends on WindowSize and STEPSIZE. Typically, using big WindowSize yields more accurate results than using small WindowSize. For example, the WindowSize can be about 30˜50% of the lengths of the string IS.

It is to be appreciated that using two substrings, substrings A and B, improves accuracy of the Bloom filter. Due to possible false positives of Bloom filters, errors are possible in characterizing membership of a query string using only the substring A. But the possibility of false probability is reduced by also checking membership of the substring (B). To improve accuracy, additional substrings that are segments of the substring A can be used for checking membership.

FIG. 2B is a simplified diagram illustrating a process for forming a Bloom filter. This diagram is merely an example, which should not unduly limit the scope of the claims herein. One of ordinary skill in the art would recognize other variations, modifications, and alternatives. In FIG. 2B, a string IS 110 is provided. For example, the string IS 110 is obtained from an input file, which is stored on a computer readable memory. String A1 120 and B1 125 are obtained by taking a segment of the string IS 110. Strings A1 120 has a length that equals to WindowSize. String B1 125 is substantially the same as string A1 120, except that string B1 125 is one character shorter than string A1 120, as shown in FIG. 2B. Both strings A1 120 and B1 125 are processed by k hash functions 160, which uses these strings to set corresponding bits in the Bloom filter 100. Similarly, substring pairs A2 130 and B2 135, which are also obtained by taking a segment of the string IS 110, are processed by the k hash functions 160 to set corresponding bits in the Bloom filter 100. The length of substring A2 130 equals to the length of substring A1 120, as defined by WindowSize. The offset, or the initial position of the substring A2 130, is defined by the variable STEPSIZE. For example, depending on the WindowSize and STEPSIZE, the substrings A1 120 and A2 130 may over lap if STEPSIZE is less than WindowSize. By an offset of STEPSIZE from the starting position of the substring A2 130, the substring A3 130 with a length of WindowSize can be obtained. The substring B3 135 can be obtained by removing the last character from the substring A3 130. Both substrings A3 130 and B3 135 are processed by k hash functions 160 to set corresponding bits of the Bloom filter 100. Depending on the WindowSize and STEPSIZE parameters, n pairs of substrings (up to substring An 150 and Bn 155) are to be used with the k hash functions, until (j+WindowSize) is greater than the length of the string IS 110.

The Bloom filter initialized in FIGS. 2A and 2B can be used to determine if a query string is similar to the source string (based on which the Bloom filter is created). As an example, a source string consists of the following characters:

### Source String: ATAGATATTACGATAGTAAGTCTCTCGAATGATGTGTCATCTG

And the query string consists of the following characters:

### Query String: ATGATGATGATATCGCGATAT

The source string and the query string may be deemed similar for a WindowSize of 10. That is, there is a 10-character segment of the query string that is similar to the same to a corresponding 10-character segment of the source string.

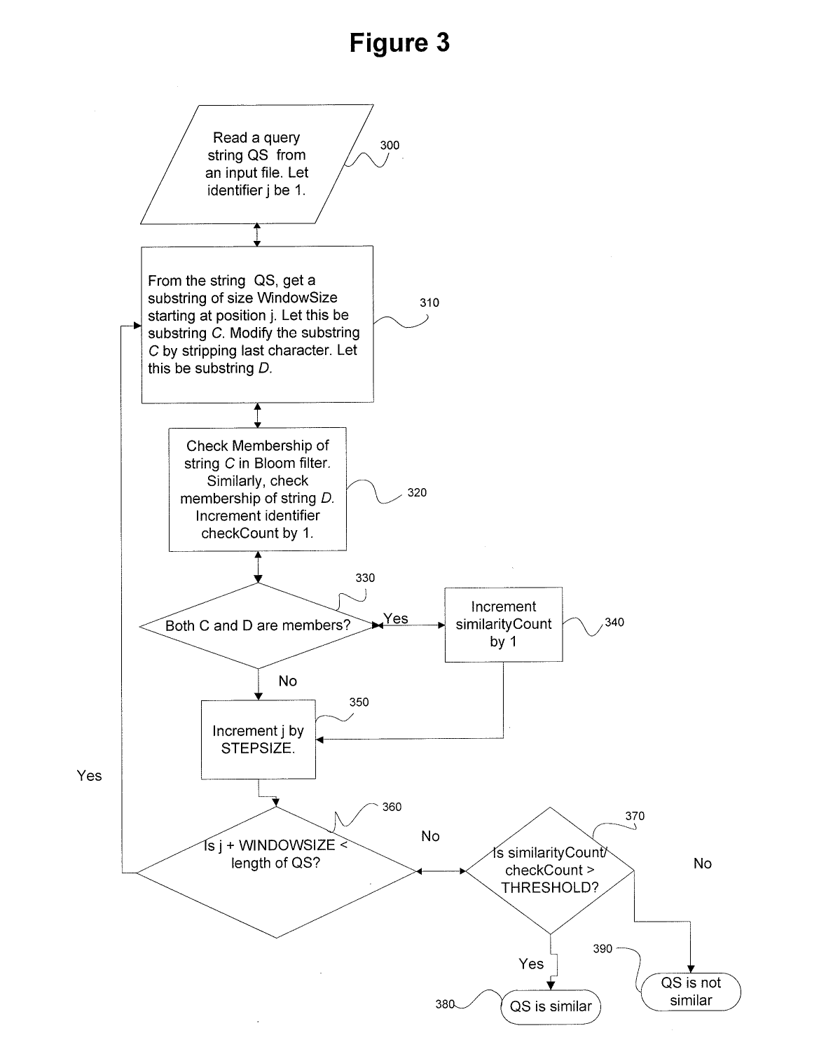

FIG. 3 is a simplified flow diagram illustrating a process for determining whether a query string is similar a source string. This diagram is merely an example, which should not unduly limit the scope of the claims. One of ordinary skill in the art would recognize many variations, alternatives, and modifications. For example, various steps illustrated in FIG. 3 can be added, removed, modified, replaced, repeated, re-arranged, and/or overlapped. For example, the Bloom filter initialized in FIG. 2A can be used. To use the Bloom filter, various parameters are used: WindowsSize, STEPSIZE, and THRESHOLD, and the Bloom filter is initialized based on the source string. In addition, the process uses variable j, checkCount, and similarityCount, are used. For example, initially the variable j has a value 1, and checkCount and similarityCount have a value of 0. The process starts at step 300. At step 300, a query string QS from an input file, which is stored in a computer readable memory, is processed. An identifier j is use and initialized with a value 1. At step 310, a substring of size WindowSize starting at position j is obtained from the query String QS. Let this substring be substring C, and by modify the substring C by stripping its last character, substring D is obtained. At step 320, the substrings C and D are respectively checked against the Bloom filter to determine whether the Bloom filter contain substrings C and D. If substring C or D is a member of the Bloom filter, then the variable checkCount is incremented by 1. Next, at step 320, it is determined whether substrings C and D are both members of the Bloom filter. If so, it proceeds to step 340 and increment the variable similarityCount by 1; if not, then it proceeds to step 350 and increment the variable j by STEPSIZE. At step 360, it is determined whether j+WindowSize less than the length of the string QS. If so, then the process goes back to step 310; if not, then the processes proceeds to step 370. At step 370, the variables similarityCount and/or checkCount are compared against the parameter THRESHOLD. If the variables similarityCount and/or checkCount is greater than THRESHOLD, then the query string QS is deemed similar to the source string; if not, then the query sting QS is deemed not similar to the source string.

The accuracy and computational speed for determining similarity depend on the parameters used. For example, by choosing the parameter WindowSize to be close to 30%-50% of the query string, the number of comparisons to be performed is greatly reduced compared to comparing the entire query string. A way to make the determination is to find if there is a substring in the source string that is common to a segment of the query string. The length of the substring segment can be defined as WINDOW SIZE. Using the techniques described above, the determination can be made in sub-quadratic in length of the source string A.

As described above, the accuracy and speed of similarity determinations depend on various parameters, which can be set by the user. To provide a Bloom filter, the parameter WindowSize (i.e., substring size) is selected, and substrings of size WindowSize in the source string are processed by k hash functions. The process can be performed by traversing the source string once and extracting substring (j, windowSize). For example, the following pseudo code is used:

For (j=0; j+WINDOWSIZE <= L_{A}; j++)
A. substr(j, windowSize_)

For example, once the Bloom filter is initialized, it can be used to determine whether a query substring of size WindowSize is a member of the Bloom filter. As explained above, it is to have false positive determinations using Bloom filters false. To reduce false positives, the following substrings can be hashed:

1. hash A.substr(j, WindowSize-STEPSIZE)

2. hash A.substr(j, WindowSize-2*STEPSIZE)

3. hash A.substr(j, WindowSize-3*STEPSIZE)

For example, in FIG. 3, each of the substring pairs includes a substring A and a substring B, and the substring B is one character shorter than the substring A. But it is to be appreciated that the substring B can in other length that is shorter than substring A (e.g., shorter by STEPSIZE, 2*STEPSIZE, etc.).

Similarly, the sizes of substrings C and D in FIG. 3 can also be have size difference STEPSIZE, STEPSIZE*2, etc. For example, by increasing the number of substrings with difference lengths, the accuracy of similarity determination can be improved.

It is to be appreciated that various processes described above can be performed very quickly. For example, let us assume the L_{A}≈L_{B} (i.e., lengths the substrings A and B are almost equal) and WindowSize is more than 50% of the query string. It is O(L_{B}) under those conditions. It is sub-quadratic even other wise since we no longer are trying to find all substrings.

In an example, a 128 MB size Bloom filter is initialized with 8 hash functions (i.e., k=8). A source string of size 272664 with window size of 1000 bits is hashed. To test the speed for calculation, a query string of size 2403 bits is tested to see if there is a substring of 1000 bits common to both. The process was completed within twenty seconds, which is faster than other methods.

In another example, a negative test is performed. A 128 MB bitmap for the Bloom filter is allocated, and source string of size 272664 with window size of 1000 bits is used. The query string has a size of 272664 bits and is initialized to all zeros. In this example, it took 14-15 seconds to answer the question for a window size of 272000 bits. The time needed to perform calculation depends on the window size. For example, if the window size is 265000 bits, then similarity test took 227 seconds. When the window size is changed to 269000, it took 77 seconds for the similarity test, and 73 seconds were needed to hash into the Bloom filter.

As can be seen from above, hashing the strings and substrings is an important process, and it often takes a lot of computational powers. The lengths of strings can be reduced to improve performance, as the amount of computation needed for processing the strings is reduced with reduction of lengths of strings. Since a string of signal is typically a bit string of 0's and 1's, a compression scheme can be used to encode of the signal. In this compression scheme, a series of 0's is compressed to a frequency count followed by symbol (0 or 1). For example string 111100000011100 is encoded as 41603120 (i.e., four 1's, six 0's, three 1's, two 0's, etc.). When we traverse the signal, we drop the 1^{st} symbol and add a new symbol (0 or 1) at the end, as illustrated in the example below:

[1]11100000011100→11100000011100→11100000011100[0];

And under the compressed scheme, the encoding “41603120” becomes the encoding “31603130”. For example, a subroutine is used to perform the conversion, and the compressed string is fed into hashing routines.

To provide a comparison, with 128 MB bitmap for the Bloom filter and source string of size 272664 with window size of 269000, it took 77 seconds for the similarity test, and 73 seconds were needed to hash into the Bloom filter. With compressed signals, for window size of 250000, it took 57 seconds for the negative test; for window size 269000, the elapsed time is 10 seconds.

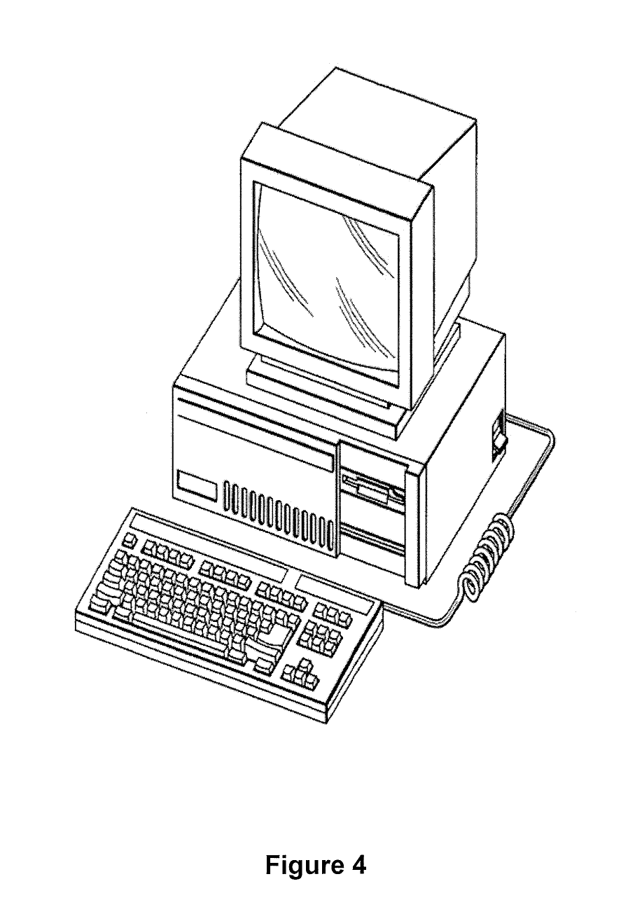

It is to be appreciated that the methods and processes described above can be implemented using various types of computing system, and the algorithm can be stored on various types of computer readable mediums. FIG. 4 is a simplified diagram illustrating a suitably configured computer that can be used to execute the methods illustrated in FIGS. 1-3 and described above. For example, the computer in FIG. 4 can be a server that performs computation and provides similarity determination information over a network.

The methods described in the present disclosure can be used for various applications. For example, by determining the similarity between a source string and a query string, it is possible to quickly determine whether the query string should be classified in the same category as the source string. A query string may be in the form of a signal string. Using a Bloom filter to determine whether a section (or the entirety) of signal string is similar to a section of a source string. The use of Bloom filter allows for quick determination at relatively high certainty. In addition, since the query string is compared to the Bloom filter instead of the source string or source file itself, the amount of memory access to the source file is reduced. These techniques can be applied in different domains, such as real-time streaming data, text mining, healthcare applications, and many others.

While the above is a full description of the specific embodiments, various modifications, alternative constructions and equivalents may be used. Therefore, the above description and illustrations should not be taken as limiting the scope of the present invention which is defined by the appended claims. It should be understood that the description recited above is an example of the invention and that modifications and changes to the examples may be undertaken which are within the scope of the claimed invention. Therefore, the scope of the appended claims should be accorded the broadest interpretation so as to encompass all such modifications and similar arrangements, including a full scope of equivalents.

1. A method for processing a data string, the method comprising:
processing a source file stored on a computer readable medium;
venerating a source string based on the source file;
initializing a Bloom filter, the Bloom filter consisting of in bits;
generating a plurality of source substring pairs based on the source string, each of the source substring pairs comprising a first string and a second string, the first string having one more character than the second string;
providing k hash functions;
applying the k hash functions to the plurality of substring pairs;
setting one or more bits of the Bloom filter based on the k hash functions and the plurality of source substring pairs;
receiving a query string; and
determining, a similarity between the query string and the source string using the Bloom filter.

2. The method of claim 1 further comprising generating a plurality of query substring pairs based on the source string each of the query substring pair comprising a first string and a second string, the first string having at least one more character than the second string.

3. The method of claim 1 further comprising providing, a similarity threshold.

4. The method of claim 1 wherein the first string being shorter than 50% of the source string.

5. The method of claim 2 further comprising determining whether the plurality of query string pairs are members of the query string using the Bloom filter.

6. A method for processing a data string, the method comprising:
processing a source file stored on a computer readable medium;
generating a source string based on the source file;
initializing a Bloom filter, the Bloom filter consisting of in bits;
generating a plurality of source substrings;
providing k hash functions;
applying, the k hash functions to the plurality of substrings;
setting one or more bits of the Bloom filter based on the k hash functions and the substrings;
receiving a query string;
venerating a plurality of query substring pairs;
determining membership relationships between the plurality of query substring pairs and the Bloom filter; and
determining a similarity between the query string and source string based at least on the membership relationships.

7. The method of claim 6 further comprising determining whether both substrings of a query substring pair are members of the Bloom filter.

8. The method of claim to wherein the source substrings comprises source substring pairs, each of the source substring pairs comprising a first string and a second string, the first string having at least one more character than the second string.

9. The method of claim to wherein each of the query substring pairs comprising a first string and a second string, the first string having one more character than the second string.

10. The method of claim 6 further comprising:
determining a count of the query substring pair being members of the Bloom filter;
comparing the count to a predetermined threshold.

11. A method for processing a data string, the method comprising:
processing a source file stored on a computer readable medium;
generating a source string based on the source file;
initializing a Bloom filter, the Bloom filter consisting of m bits;
generating a plurality of source substrings;
providing k hash functions;
applying the k hash functions to the plurality of substrings;
setting one or more bits of the Bloom filter based on the k hash functions and the substrings;
receiving a query string;
generating a plurality of query substring;
determining membership relationships between the plurality of query substring and the Bloom filter;
determining a count of the query substrings being members of the Bloom filter; and
comparing the count to a predetermined threshold.

12. The method of claim 1 further comprising compressing the query string.

13. The method of claim 11 further comprising determining whether both substrings of a query substring pair are members of the Bloom filter.

14. The method of claim 11 wherein the source substrings comprises source substring pairs, each of the source substring pairs comprising a first string and a second string, the first string having one more character than the second string.

15. The method of claim 11 wherein the plurality of query substring comprises query substring pairs, each of the query substring pairs comprising a first string and a second string, the first string having one more character than the second string.

16. The method of claim 3, further comprising comparing, variables similarityCount and checkCount against the similarity threshold, wherein the query string is similar to the source source string if the variables similarityCount and checkCount are greater than the similarity threshold.

17. The method of claim 1, wherein a length of the first string is defined by WindowSize, and a length of the second string one character shorter than the first string.

18. The method of claim 17, wherein a second substring pair is obtained by taking a segment of the source string offset from a first substring pair by a variable STEPSIZE.

19. The method of claim 18, wherein the second substring pair overlaps the second substring pair.

20. The method of claim 1, wherein the second string in each substring pair is obtained by removing a last character from the first string in the same substring pair.
